(19) United States
(12) Patent Application Publication
(10) Pub. No.: US 2025/0368914 A1
(43) Pub. Date: Dec. 4, 2025

(54) MACHINE COMPONENT WITH A COATING AND PROCESS FOR MAKING THE SAME

(71) Applicant: AKTIEBOLAGET SKF, GOTEBORG (SE)

(72) Inventor: Warrick James David ALLEN, Hilversum (NL)

(21) Appl. No.: 18/870,709

(22) PCT Filed: Jun. 6, 2023
(86) PCT No.: PCT/EP2023/065090

§ 371 Date: Dec. 2, 2024

(30) Foreign Application Priority Data
Jun. 9, 2022 (WO) PCT/EP2022/065759

(51) Int. Cl. C10M 111/04; C10M 107/50; C10N 50/00; F16C 33/12

(52) U.S. Cl. CPC C10M 111/04; C10M 107/50; F16C 33/121; F16C 33/122; C10M 2201/0853; C10M 2229/0525; C10N 2050/023; F16C 2223/42; F16C 2223/60

(57) ABSTRACT

A machine component has a first tribological surface contacts a second tribological surface of another machine component during a machine operation. At least part of the first tribological surface is covered with a coating that includes a first coating layer and a second coating layer. The first coating layer includes an inorganic protective coating composition that is a chemically produced coating composition containing at least one of black oxide or manganese phosphate. The second coating layer includes an organically modified silane composition, in which an organically modified silane in the organically modified silane composition contains one or more amine groups. The first coating layer is in direct contact with at least part of the first tribological surface, and the second coating layer is in direct contact with at least part of the first coating layer.

### CROSS-REFERENCE

This application is the US national stage of International Patent Application No. PCT/EP2023/065090 filed on Jun. 6, 2023, which claims priority to International Patent Application No. PCT/EP2022/065759 filed on Jun. 9, 2022.

### FIELD OF THE INVENTION

The present invention generally relates to a machine component having a first tribological surface, which first tribological surface, during machine operation, is adapted to be in contact with a second tribological surface of another machine component; to a process for preparing the coating on at least part of a first tribological surface of a first machine component which, during machine operation, is adapted to be in contact with a second tribological surface of another machine component; and the use of the coating on at least part of a first tribological surface of a first machine component for protecting the first machine component.

### BACKGROUND OF THE INVENTION

In applications where sliding or rolling contact between two tribological surfaces occur under conditions that are not optimal, for example when excessive loads are experienced or with contaminated lubrication causing corrosion, it is possible for premature wear and fretting of the bearing to occur.

Therefore, in addition to or instead of using a lubricant, it can be beneficial to apply a protective coating to the tribological surface of a machine component that is in contact with another surface. Many different types of coatings exist, and include for instance galvanic coatings, polymer coatings, thermally sprayed coatings and chemically produced coatings.

Two commonly used types of inorganic protective coatings are black oxide coatings and manganese phosphate coatings that are chemically produced. Black oxide coatings are black conversion layers that are formed when the steel is oxidised in controlled caustic conditions to produce specific iron oxide species at the surface. Manganese phosphate coatings are grey to black layers that are formed when a machine component is immersed into a manganese phosphate fluid and the iron in the machine component reacts with the manganese cations and the phosphate anions in the fluid. Although these inorganic protective coatings provide numerous advantages for improving bearing performance such as anti-wear, anti-corrosion, and anti-fretting performances, they still leave room for improvement.

### SUMMARY OF THE INVENTION

It is therefore one non-limiting object of the present teachings to disclose an inorganic protective coating which provides improved rolling or sliding performances when compared to known organic protective coatings such black oxide coatings and manganese phosphate coatings.

In one aspect of the present teachings, this object can be realized by using a particular additional coating layer which is applied onto a conventional coating layer.

Accordingly, in another aspect of the present teachings, a machine component has a first tribological surface, which first tribological surface, during machine operation, is adapted (configured) to be in contact with a second tribological surface of another machine component, wherein at least part of the first tribological surface is covered with a coating which comprises a first coating layer and a second coating layer, wherein the first coating layer comprises an protective coating composition and the second coating layer comprises an organically modified silane composition, wherein the organically modified silane used in the organically modified silane composition contains one or more amine groups, wherein the first coating layer is in direct contact with at least part of the first tribological surface, and wherein the second coating layer is in direct contact with at least part of the first coating layer.

The inorganic protective coating composition is preferably a chemically produced coating composition.

In one preferred embodiment, the protective coating composition comprises one or more iron oxides. Suitably, the inorganic protective coating composition comprises at least Fe₃O₄. Preferably, the protective coating composition comprises black oxide.

Therefore, in another aspect of the present teachings, a machine component has a first tribological surface, which first tribological surface, during machine operation, is adapted (configured) to be in contact with a second tribological surface of another machine component, wherein at least part of the first tribological surface is covered with a coating which comprises a first coating layer and a second coating layer, wherein the first coating layer comprises an inorganic protective coating composition which comprises one or more iron oxides and the second coating layer comprises an organically modified silane composition, wherein the organically modified silane used in the organically modified silane composition contains one or more amine groups, wherein the first coating layer is in direct contact with at least part of the first tribological surface, and wherein the second coating layer is in direct contact with at least part of the first coating layer.

In another preferred embodiment, the inorganic protective coating compositions comprises manganese phosphate (Mn₃(PO₄)₂) and/or hydrated manganese phosphate hydroxide (Mn₅H₂(PO₄)₄).

In another aspect of the present teachings, a machine component has a first tribological surface, which first tribological surface, during machine operation, is adapted (configured) to be in contact with a second tribological surface of another machine component, wherein at least part of the first tribological surface is covered with a coating which comprises a first coating layer and a second coating layer, wherein the first coating layer comprises an inorganic protective coating composition which comprises manganese phosphate and/or hydrated manganese phosphate hydroxide and the second coating layer comprises an organically modified silane composition, wherein the organically modified silane used in the organically modified silane composition contains one or more amine groups, wherein the first coating layer is in direct contact with at least part of the first tribological surface, and wherein the second coating layer is in direct contact with at least part of the first coating layer.

Preferably, the inorganic protective coating composition comprises manganese phosphate (Mn₃(PO₄)₂).

Therefore, in another aspect of the present teachings, a machine component has a first tribological surface, which first tribological surface, during machine operation, is adapted (configured) to be in contact with a second tribological surface of another machine component, wherein at least part of the first tribological surface is covered with a coating which comprises a first coating layer and a second coating layer, wherein the first coating layer comprises an inorganic protective coating composition which comprises manganese phosphate and the second coating layer comprises an organically modified silane composition, wherein the organically modified silane used in the organically modified silane composition contains one or more amine groups, wherein the first coating layer is in direct contact with at least part of the first tribological surface, and wherein the second coating layer is in direct contact with at least part of the first coating layer.

The second coating layer to be used in accordance with the present teachings preferably has a thickness in the range of from 25-500 nm, preferably in the range of from 25-250 nm, more preferably in the range of from 50-200 nm, and most preferably in the range of from 50-150 nm.

Use of the second coating layer results in an improved bearing performance. In case the inorganic protective coating composition comprises one or more iron oxides (i.e. black oxide), use of the second coating layer results in an improved run-in process in the sense that it generates less noise and friction when compared with a coating which is made only of black oxide. In addition, the second coating layer improves oil adhesion, and thus improves lubricating performance after the run-in. In that case a relatively smooth coating surface is obtained.

In case the inorganic protective coating composition comprises manganese phosphate (Mn₃(PO₄)₂) and/or hydrated manganese phosphate hydroxide (Mn₅H₂(PO₄)₄), use of the second coating layer results in improved wear resistance, friction reduction and corrosion resistance. When using the organically modified silane in accordance with the present teachings, a longer running time can be established. The surface of the manganese phosphate crystals will be covered with the organically modified silane, whereby the organically modified silane containing one or more amino groups will act as an elastomeric binder which holds the manganese phosphate crystals together, thereby ensuring an improved retention of manganese phosphate crystals during use and lubricant adhesion, and thus resulting in improved wear resistance, friction reduction and corrosion resistance. Further, at least part of the organically modified silane will penetrate the porous structure of the first coating layer comprising manganese phosphate crystals, thereby also providing a binder coating layer between manganese phosphate crystals that are not immediately arranged at the outer surface of the first coating layer. Such internal binding in the porous structure of the manganese phosphate-containing first coating layer further contributes to the high retention of the manganese phosphate crystals in the first coating layer, and thus contributes to improved performance.

Hence, in a preferred embodiment of the present teachings, the inorganic protective coating composition in the first coating layer comprises manganese phosphate, wherein at least part of the second coating layer which comprises the organically modified silane that contains one or more amino groups covers the outer surface of the first coating layer, and wherein at least part of said second coating layer has penetrated an internal part of the first coating layer.

In accordance with another aspect of the present teachings, the organically modified silane used in the organically modified silane composition contains one or more amino groups. Preferably, the organically modified silane contains two or more amine groups. More preferably, the organically modified silane contains two amine groups. Organically modified silanes containing one or more amino groups have the advantage that they exhibit improved adhesion to the first coating which comprises a protective coating, thereby resulting in improved performances in terms of anti-wear, anti-corrosion and anti-fretting performances over a longer period of time. The one or more amino groups will create a strong coordination bond to metal ions such as manganese ions (Mn²⁺) and iron ions (Fe²⁺ and Fe³⁺). In addition, the one or more amino groups improve the corrosion inhibiting properties of the coating. Hence, organically modified silanes containing one or more amino groups will perform more attractively when compared with organically modified silanes that do not contain amino groups and that require organic solvents such as for instance 1,2-bis(triethoxysilyl) ethane and triethoxysilyl propoxy(polyethyleneoxy) dodecanate.

Preferably, the organically modified silane which is used in the organically modified silane composition to be used in accordance with the present teachings is water-soluble.

For example, the organically modified silane to be used in the organically modified silane composition may have a R—Si—(OX)₃ structure, in which R is an organofunctional group, and X is independently hydrogen or an alkyl group, preferably a methyl or ethyl group. The first, second and third X can be the same or different. For instance, the first and second X can be the same, whereas the third X differs from the first and second X. Preferably, the first, second and third X are all the same. More preferably, X is hydrogen (i.e. the first, second and third X are hydrogen).

Suitably, R contains 1-50 carbon atoms, preferably 5-20 carbon atoms. R contains one or more amine groups. R may also contain one or more unsaturated C—C bonds. Preferably, R contains two or more amine groups. More preferably, R contains two amine groups. The organically modified silane is suitably selected from the group of monomers or oligomers consisting of 4-aminobutyltriethoxysilane, 4-amino-3,3-dimethylbutyltrimethoxysilane, 4-amino-3,3-dimethylbutylmethyldimethoxysilane, 3-aminopropylmethyldiethoxysilane, N-(2-aminoethyl)-3-aminopropyltrimethoxysilane, N-(2-aminoethyl)-3-aminoisobutylmethyldimethoxysilane, N(2-aminoethyl)-3-aminopropylmethyldiethoxysilane, N(2-aminoethyl)-3-aminopropylethyldimethoxysilane, (trimethoxysilylpropyl)diethylenetriamine, 3-(N-allylamino)propyltrimethoxysilane, n-butylaminepropyltrimethoxysilane, (3-N-ethylamino)isobutylmethyldiethoxysilane, (3-(N-ethylamino)isobutyltriethoxysilane, N-methylaminopropylmethyldimethoxysilane, N-methylaminopropyltrimethoxysilane, 3-(N,N-dimethylaminopropyl)aminopropylmethyldimethoxysilane, N-(2-aminoethyl)-3-aminopropyltriethoxysilane, 3-aminopropyltriethoxysilane, 3-aminopropyltrimethoxysilane, N-(2-aminoethyl)-3-aminopropylsilanetriol, N-(2-aminoethyl)-3-aminoisobutyldimethylsilane triol, n-butylaminopropylsilanetriol, 4-aminobutylsilanetriol, 4-amino-3,3, dimethylbutylsilanetriol, 3-aminopropylsilanetriol, N-(2-aminopropyl)-3-aminopropylsilanetriol, 3-mercaptopropylsilanetriol, aminoethyl silsesquioxane, aminoethyl aminopropyl silsesquioxane, N-(2-aminoethyl)-3-aminopropylsilanetriol, and N-(2-aminoethyl)-3-aminoethylsilanetriol.

As indicated above, in the organically modified silane to be used in accordance with the present teachings, X is preferably hydrogen. Preferably, the organically modified silane is selected from the group consisting of aminoethyl silsesquioxane, aminoethyl aminopropyl silsesquioxane and N-(2-aminoethyl)-3-aminopropylsilanetriol. More preferably, the organically modified silane is aminoethyl-aminopropyl silsesquioxane or N-(2-aminoethyl)-3-aminopropylsilanetriol. Most preferably, the organically modified silane which is used in the organically modified silane composition is N-(2-aminoethyl)-3-aminopropylsilanetriol. Mixtures of organically modified silanes also can be used. An example of such a mixture comprises aminoethyl-aminopropyl silsesquioxane and N-(2-aminoethyl)-3-aminopropylsilanetriol.

The organically modified silane composition may comprise an organically modified silane, in which one or more of the amino groups of the organically modified silane has (have) reacted with another chemical compound such for example an ester to provide the coating with particular surface properties.

In case the first coating layer comprises manganese phosphate (Mn₃(PO₄)₂) and/or hydrated manganese phosphate hydroxide (Mn₅H₂(PO₄)₄), the one or more functional groups that are present in the R group of the organically modified silane, such as one or more amine groups and/or sulphuric acid groups, are able to form coordinating structures with the manganese cations, thereby ensuring that the second coating layer is firmly bound to the first coating layer, thus providing a very stable coating with an improved adhesion behaviour and thus improved bearing performance in terms of wear reduction and corrosion resistance.

The first coating layer is in direct contact with at least part of the first tribological surface of the machine component. Preferably, the first coating layer is in direct contact with more than 75% of the first tribological surface, preferably more than 95% of the first tribological surface. Most preferably, the entire first tribological surface is covered with the first coating layer. Suitably, the second coating layer is in direct contact with at least part of the first coating. Preferably, the second coating layer is in direct contact with more than 75% of the first contact layer, more preferably more than 95% of the first contact layer. Most preferably, the entire first coating layer is covered with the second coating layer.

In another aspect of the present teachings, a process for preparing a coating on at least part of a first tribological surface of a first machine component which, during machine operation, is adapted (configured) to be in sliding contact with a second tribological surface of another machine component, comprises:
(a) applying a first coating layer onto at least part of the first tribological surface, which first coating layer comprises a protective coating composition, and wherein the first coating is in direct contact with at least part of the first tribological layer;
(b) applying a second coating layer onto at least part of the first coating layer, which second coating layer comprises an organically modified silane, wherein the organically modified silane used in the organically modified silane composition contains one or more amine groups, and wherein the second coating layer is in direct contact with at least part of the first coating layer; and
(c) allowing the second coating to cure.

In accordance with this aspect of the present teachings, the organically modified silane used in the organically modified silane composition contains one or more amino groups. These organically modified silanes containing one or more amino groups enable a very attractive process for preparing the coating which comprises the first and second coating layers in accordance with the present invention. The one or more amino groups that are present in the organically modified silane enable the curing of the second coating layer to be carried out at room temperature (i.e. avoiding the use of an oven) and during relative short curing periods. Another advantage of the use of an organically modified silane that contains one or more amino groups is that the organically modified silane can be applied in the form of an aqueous solution onto at least part of the first coating layer, and that no organic solvents need be used, resulting in an environmentally friendly and safe manufacturing process. An additional advantage is the fact that the aqueous solution of the organically modified silane containing one or more amino groups exhibits improved stability when compared with organically modified silanes that do not contain amino groups and that require organic solvents such as for instance 1,2-bis(triethoxysilyl) ethane and triethoxysilyl propoxy(polyethyleneoxy) dodecanate. This means that the aqueous solutions of the organically modified silanes that contain one or more amino groups according to the present teachings can be stored for longer until needed.

In step (a), the first coating layer is applied into at least part of the first tribological surface of the machine component. Preferably, the first coating layer is applied onto more than 75% of the first tribological surface, preferably more than 95% of the first tribological surface. Most preferably, the first coating layer is applied onto the entire first tribological surface. In step (b), the second coating is applied onto at least part of the first coating layer. Preferably, the second coating layer is applied onto more than 75% of the first contact layer, preferably more than 95% of the first contact layer. Most preferably, the second coating layer is applied onto the entire first coating layer.

Step (a) is carried out under conditions which are commonly used to apply inorganic protective layers on a tribological surface of a machine component. Such methods include conversion coating by chemical immersion, vacuum deposition including PVD techniques (physical vapour deposition), thermal spraying and kinetic spraying techniques.

In accordance with another aspect of the present teachings, in step (b), the organically modified silane can suitably be applied onto at least part of the first coating layer by dip coating, contact coating, roller coating or spray coating process. The polymer formulation is preferably applied onto at least part of the first coating layer by a spray, spin or dip coating process or a combination of two or more of these.

The organically modified silane can be any one of those described herein above. Preferably, in the organically modified silane to be used, X is hydrogen. Organically modified silanes in which X is hydrogen have the advantage that they are water soluble and that the use of organic and environmentally unfriendly solvents can be avoided. Therefore, in step (b) the organically modified silane is preferably in the form of an aqueous solution which is applied onto at least part of the first coating layer.

Step (b) is suitably carried out for a period of time in the range of from less than a minute to 15 minutes and at a temperature in the range of from 5-80° C. Preferably, step (b) is carried out for a period of time in the range of from less than a minute to 5 minutes and at a temperature in the range of from 15-35° C.

When in step (b) an aqueous solution is used which contains the organically modified silane in which X is hydrogen, the organically modified silane is present in an amount in the range of 0.1-25 wt %, preferably in the range of 0.5-5 wt %, based on the total weight of the aqueous solution.

When X is an alkyl group such as a methyl group or ethyl group, use is made of an organic solution in which the organically modified silane is dissolved in a solvent. In that case the organically modified silane is present in an amount in the range of 0.1-20 wt %, preferably in the range of 0.5-5 wt %, based on the total weight of the organic solution.

Suitably, the solvent is a polar organic solvent. The polar solvent may be a polar aliphatic solvent or polar aromatic solvent, such as an alcohol, a ketone, ester, acetate, glycol ethers, aprotic amide, aprotic sulfoxide, or aprotic amine. Examples of useful solvents include methyl ethyl ketone, methyl isobutyl ketone, m-amyl acetate, ethylene glycol butyl ether-acetate, propylene glycol monomethyl ether acetate, xylene, n-methylpyrrolidone, or blends of aromatic hydrocarbons. Suitable alcohols include ethanol, isopropanol, n-butanol, and n-propanol. Suitable acetates include hexyl acetate, octyl acetate, and glycol ether acetates such as propylene glycol monomethyl ether acetate. Suitable ketones include methyl propyl ketone, methyl isobutyl ketone, and methyl hexyl ketone. Glycol ethers and glycol ether acetates are especially preferred. An acidic or basis catalyst may also be added. Further, the solvent may include non-polar aromatic and/or aliphatic solvents.

Step (c) is suitably carried out for a period of time in the range of 3-30 days and at a temperature in the range of from 5-80° C. Preferably, step (c) is carried out for a period of time in the range of 7-21 days and at a temperature in the range of 15-30° C. Step (c) will allow the coating to cure by way of drying. Once the second coating has been cured, the first component will be ready for use.

In another aspect of the present teachings, a coating can be used on at least part of a first tribological surface of a first machine component for protecting the first machine component, which first tribological surface, during machine operation, is adapted (configured) to be in contact with a second tribological surface of another machine component, which coating comprises a first coating layer and a second coating layer, wherein the first coating layer comprises a protective coating composition and the second coating layer comprises an organically modified silane, wherein the organically modified silane used in the organically modified silane composition contains one or more amine groups, wherein the first coating layer is in direct contact with at least part of the first tribological surface, and wherein the second coating layer is in direct contact with at least part of the first coating layer. Preferably, the present coating is also used on at least part of the second tribological surface of the other machine component.

Use of the coating comprising the first coating layer and the second coating layer in accordance with the present teachings provides improved performances in rolling or sliding applications in which high contact pressures are required between the tribological surfaces of machine components to establish sufficient hydrodynamic lubrication.

Therefore, in a preferred embodiment, the coating can be used on at least part of a first tribological surface of a first machine component for protecting the first machine component in rolling applications, which first tribological surface, during machine operation, is adapted (configured) to be in rolling or sliding contact with a second tribological surface of another machine component, which coating comprises a first coating layer and a second coating layer, wherein the first coating layer comprises an protective coating composition comprising a manganese phosphate and the second coating layer comprises an organically modified silane, wherein the organically modified silane used in the organically modified silane composition contains one or more amine groups, wherein the first coating layer is in direct contact with at least part of the first tribological surface, and wherein the second coating layer is in direct contact with at least part of the first coating layer.

Preferably, the present coating is also used on at least part of the second tribological surface of the other machine component.

In another aspect of the present teachings, a machine comprises a first machine component on which a coating is formed using a process according to the present teachings and a second machine component which is in contact with the first machine component.

Such machine in accordance with the present teachings may be an enclosed machine in which the first machine component and the second machine component are not exposed to external conditions such as weather conditions.

In one embodiment, the first machine component and the second machine component form part of a dynamic sealing assembly comprising a dynamic seal having a contact lip that bears against a counterface. The counterface can be a surface of a shaft, or of a part fixedly mounted to the shaft such as a flinger or a bearing inner ring, that is rotatable relative to the seal. In a further example, the counterface is a surface of a cylinder housing or piston that is linearly displaceable relative to the seal. The coating may be provided on a contact surface of the seal lip and/or on the counterface.

The dynamic seal may thus be used to seal passages between machine components that move relative to each other, either linearly or in the circumferential direction. The dynamic seal may be, for example, a lip seal of a rolling element bearing, an engine seal (such as, for example, a valve stem seal, a crankshaft seal or a shaft seal), an O-ring seal, a steering seal, a suspension seal, a piston seal, a wheel end seal, a power transmission seal, a pneumatic seal, a hydraulic seal, a fluid handing seal or an aerospace shaft seal.

In a further embodiment, the first and second machine components form part of a plain bearing assembly. In one example, the plain bearing assembly is a radial assembly comprising oppositely oriented radial surfaces in sliding contact with each other, for supporting and transmitting radial loads. One of the first and second components is an inner component, such as a shaft, or a part fixedly mounted to the shaft such as a sleeve, bushing or the inner ring of a plain bearing. The other of the first and second components is an outer component, such as a housing or a part that is fixedly mounted to the housing, such as the outer ring of a plain bearing or a sleeve or bushing. The coating may be provided on a radially outer surface of the inner component and/or on a radially inner surface of the outer component. In a further example, the plain bearing assembly is a thrust bearing assembly comprising oppositely oriented axial surfaces in sliding contact with each other, wherein the coating is provided on one or both axial surfaces.

The first machine component can suitably be derived from an iron containing material such as selected from the group consisting of chrome steels and stainless steels. Examples of suitable stainless steels include martensitic grades such as 410 and 410H, austenitic grades such as 304 and 316, ferritic grades such as 410S, duplex grades such as 2205 and precipitation hardened grades such as 17-4 PH. Preferably, the first machine component is made of steel.

A coating prepared in accordance with the present teachings may also be used advantageously in rotary sealing applications.

In an alternative embodiment, the outer surface of the shaft or of a sleeve mounted to the shaft is provided with the coating.

### BRIEF DESCRIPTION OF THE DRAWING

FIG. 1 shows a machine component in accordance with the present teachings.

### DETAILED DESCRIPTION OF THE INVENTION

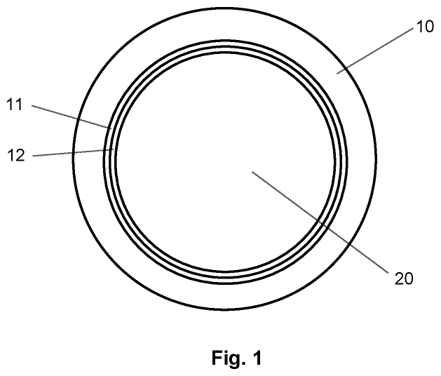

In FIG. 1, a machine component in accordance with one aspect of the present teachings is shown which comprises an outer sliding element 10 of a sliding bearing as the machine component, a first coating layer 11, a second coating 12, and an inner sliding element 20 of the sliding bearing as the another machine component.

Advantages of the invention will become apparent from the following examples.

### EXAMPLES

### Example 1

### Water Based Sol-Gel Coating on Manganese Phosphate Coated Steel Part

Silane 2-aminoethyl-3-aminopropyl silanetriol was obtained as a 25 wt % concentrate in water (Gelest Inc.). It was then diluted in tap water to reach a concentration of 1% by volume and mixed thoroughly to make the sol-gel treatment solution.

Several flat steel rings (diameter ˜5 cm) made from grade 3 steel that had been previously surface treated to produce a Mn phosphate coating were thoroughly cleaned, once by immersion in 2-propanol and twice by immersion in 2-butanone (HPLC grade), followed by an additional rinse in the same grade of 2-butanone. The sample rings were then left to dry.

Each cleaned phosphated steel ring was then immersed briefly in the sol-gel solution and then steadily removed at a rate of approximately 2 cm per second. Each ring was held above the dip solution until most of the wet coating was removed by gravity, and then placed onto a flat surface to dry at room temperature for 2 weeks.

A contact angle with deionized water between 65°-70° was achieved, thereby exhibiting a considerably increased hydrophobicity versus a clean and uncoated Mn phosphate steel part that had a contact angle of less than 10°. The increased hydrophobicity is a clear indication of increased wear resistance.

### Example 2

### Solvent Based Sol-Gel Coating on Black Oxide Coated Steel Part

A mixture of deionized water (10 ml) and 2-propanol (70 ml) was prepared in a glass beaker and stirred continuously with a magnetic stirrer bar. 2 drops of acetic acid (dilute) were then added, followed by 0.4 ml of silane 1,2-bis(triethoxysilyl) ethane (96% purity, Merck KGaA) and 2.0 ml of silane triethoxysilyl propoxy(polyethyleneoxy) dodecanoate (Gelest Inc, 95%). The solution was heated to approximately 60° C. for 1 hour and left to cool with continued stirring throughout the mixing and reaction.

Several flat steel rings (diameter ˜5 cm) made from grade 3 steel that had been previously surface treated to produce a black oxide coating were thoroughly cleaned, once by immersion in 2-propanol and twice by immersion in 2-butanone (>99.9%), followed by an additional rinse in the same grade of 2-butanone. The sample rings were then left to dry.

Each cleaned black oxide treated steel ring was then immersed briefly in the sol-gel solution and then steadily removed at a rate of approximately 2 cm per second. Each ring was held above the dip solution until most of the wet coating was removed by gravity, then placed flat for 5 minutes for initial drying, followed by heating in an oven for 1 hour at 100° C.

The resulting coated part had a slightly darker appearance than an uncoated ring with a contact angle with deionized water of approximately 65°, thereby exhibiting increased hydrophobicity versus a cleaned, uncoated black oxide ring that had a contact angle of approximately 0° with deionized water.

### Example 3

### Water Based Sol-Gel Coating on Black Oxide Coated Steel Part

The sol-gel made in Example 1 was also applied to a cleaned black oxide treated grade 3 steel ring using an identical cleaning and processing used for Example 2.

A contact angle with deionized water of approximately 65° was achieved, whereas with a clean and uncoated steel part a contact angle of approximately 0° was obtained with deionized water.

### Example 4

### Emulsion Method of Sol-Gel Coating on Manganese Phosphate Coated Steel Part

0.4 ml of silane 1,2-bis(triethoxysilyl) ethane (96% purity, Merck KGaA), 2.0 ml of silane triethoxysilyl propoxy(polyethyleneoxy) dodecanoate (Gelest Inc, 95%) and 2 drops of dilute acetic acid were added to 50 ml of deionized water with vigorous stirring using magnetic bar. Approximately 2 ml of an aqueous solution containing Polaxomer 407 surfactant was added to yield an approximately 0.1% w/w concentration in the final mixture with vigorous stirring maintained until a cloudy emulsion of silane droplets in water was achieved.

A Mn phosphate treated ring was cleaned using the same process as for Example 1. A portion of the emulsion/suspension produced above was poured onto the cleaned Mn phosphate coated ring and the excess was poured away. The coated ring was then placed in an oven at 100° C. for 1 hour to produce a cured coating that produced a contact angle of of approximately 45° with deionized water after cooling, whereas with a clean and uncoated steel part a contact angle of approximately 0° was obtained with deionized water.

Examples 1-4 clearly show that the use of the second coating layer in accordance with the present teachings results in a significantly improved hydrophobicity, which in turn will lead to a considerable increase in wear and corrosion resistance.

### Example 5

### Water Immersion Rust Resistance Test of a Water Based Sol-Gel Coating on a Mn Phosphate Steel Part

The sol-gel coating made in Example 1 using 2-aminoethyl-3-aminopropyl silanetriol on the Mn phosphate ring that was also previously tested for MTM tribology testing was cleaned and placed into a beaker of tap water and maintained at 70° C. for 4 days. A reference ring with Mn phosphate but with no sol-gel treatment, which was also previously tested in an identical way for its tribology using an MTM, was placed into a separate beaker of water with identical conditions at the same time. The parts were then removed after this 4 day period and gently dried; the parts were then examined for rust corrosion. The sol-gel coated sample showed very little red rust compared to the reference sample without sol-gel coating, which showed much more red coloration from iron rust. SEM with EDS (Energy Dispersive X-Ray Spectroscopy) was also used to confirm the increase in oxygen levels in the more rusted areas of the reference sample without sol-gel treatment.

### Example 6

### Potentiodynamic Measurements of a Solvent Sol-Gel Treated Manganese Phosphate Coated Part

Potentiodynamic polarization was performed in a double jacketed cell using a three-electrode system. The steel specimen was acting as a working electrode. A platinum electrode was used as an auxiliary electrode and a silver/silver chloride electrode was used as a reference electrode. The reference electrode was inserted into a lugging capillary to minimize the electrical potential difference between the two ends of a conducting phase during current flow.

The experiments were performed in a 3.5 wt % NaCl solution with continuously purging of nitrogen gas at two temperatures (21 and 60° C.) using a VersaSTAT® 3F Potentiostat Galvanostat from AMETEK®. Each steel specimen was dipped into the 3.5% NaCl solution for 180 minutes to achieve the steady state before each experiment. The potentiodynamic anodic and cathodic polarization plots were attained from −1200 mV versus reference electrode to +700 mV versus reference electrode potential at a scan rate of 0.0833 mV/s.

The following values were obtained for the Mn phosphate plate coated with sol-gel from Example 2 (containing triethoxysilyl propoxy(polyethyleneoxy) dodecanoate and bis(triethoxysilyl) ethane). One reading was taken after the sol-gel was taken directly after heat treatment with no cleaning and another with the sol-gel coating cleaned to remove any residue that may obscure the real value associated with the solid sol-gel coating formed. This successfully demonstrated that the sol-gel coating provides a much lower I_{corr}, suggesting it would provide a useful improvement in corrosion resistance.

These results are shown in Table 1.

TABLE 1

| Sample | E_{corr} (mV) | I_{corr} (μA) | Pᵢ (%) |
|---|---|---|---|
| Mn phosphate reference | −694 | 1.428 | — |
| Mn phosphate + sol-gel | −682 | 0.090 | 93.7 |
| (no cleaning after deposition) | | | |
| Mn phosphate + sol-gel | −431 | 0.308 | 78.5 |
| (cleaned after deposition) | | | |

### Example 7

### Tribology of Solvent Based Sol-Gel Coating on a Black Oxide Coated Part

The tribological behaviour of the solgel made in Example 1 was studied using a Mini-Traction Machine (specifically, a MTM2 system). MTM® is a ball on disc tester from PCS Instruments. The contact pressures, speeds and temperature that can be achieved in the MTM2 contact were similar to those found in gears, rolling element bearings and cams.

The ball used was a super finished AISI 52100 (535A99) test ball, R_{q} 10 nm. The sol-gel on black oxide and black oxide treated steel disks were made of grade 3 steel with an initial R_{q} 250 nm of the uncoated steel. A formulated mineral oil (Lukoil Genesis 0W20) was used for each experiment.

Table 2 shows the parameters used to study friction and tribofilm formation. Stribeck and duration tests were done, and each test was repeated twice to check the reproducibility of the results.

TABLE 2

| | Contact Pressure | Load | Temperature | | Speed | |
|---|---|---|---|---|---|---|
| Test Type | P₀, (GPa) | (N) | (° C.) | SRR % | (mm/s) | λ |
| Stribeck | 1.28 | 75 | 40 | 5 | variable | variable |
| Duration | 1.28 | 75 | 40 | 5 | 800 | 1.1 |

Table 3 shows that lower friction was achieved during the initial, running-in phase of the test.

TABLE 3

| | | Load | Distance | Initial | Steady State |
|---|---|---|---|---|---|
| Ball | Washer | (N) | (m) | Friction | Friction |
| Black | Black | 75 | 144 | 0.045-0.065 | 0.040-0.045 |
| Oxide | Oxide | | | | |
| Black | Sol-gel | 75 | 144 | <0.05 | 0.04-0.045 |
| Oxide | coated | | | | |
| | Black | | | | |
| | Oxide | | | | |

### Example 8

Deposition onto a Cylindrical Bearing Unit

A water based sol-gel treatment made using the same process as Example 1 was also deposited onto a cleaned Mn phosphate treated cylindrical roller bearing of 10 mm diameter×20 mm length. The part was cleaned and coated using the same process and yielded a very similar contact angle when fully cured; it appeared to be of good quality and uniformity.

### Example 9

### Tribology of Water Based Sol-Gel Coating on a Manganese Phosphate Coated Part

Tribological behaviour of the water based sol-gel produced on manganese phosphate from the sol-gel made in Example 1 was also studied using the same MTM® (Mini Traction Machine) used in Example 7. Stribeck testing was performed on samples and compared to reference samples of manganese phosphate coatings without sol-gel treatment.

A sequence of 6 Stribeck steps were programmed with speeds that varied between 50-2500 mm/s from high speed to low speed and the reverse 3 times with the test parameters shown in Table 4. Average traction coefficients were then measured during 3 duration steps of 5 minutes each with different speeds and/or Spin to Roll Ratio, as shown in Table 5. The test results are shown in Table 6.

TABLE 4
Test Conditions for Friction Tests

| Contact Pressure | Load | Temperature | | Speed |
|---|---|---|---|---|
| P₀, (GPa) | (N) | (° C.) | SRR % | (mm/s) |
| 1.28 | 75 | 90 | 50-190 | variable |

TABLE 5
Description of each step

| Parameter | Step 1 | Step 2 | Step 3 |
|---|---|---|---|
| Speed (mm/s) | 500 | 500 | 150 |
| SRR (%) | 50 | 100 | 100 |

TABLE 6
Results

| | Traction coefficient | | |
|---|---|---|---|
| Sample | Step 1 | Step 2 | Step 3 |
| Mn phosphated steel | 0.12 | 0.12 | 0.12 |
| Sol-gel coated Mn phosphated steel | 0.10 | 0.10 | 0.11 |

After testing was completed, the profile of each wear track that was in tribological contact was measured and the maximum wear depth was recorded (see Table 7)

TABLE 7
Wear depth of samples

| Sample | Wear depth (μm) |
|---|---|
| Reference Mn phosphated steel | 6.1 (average) |
| Sol-gel on Mn phosphated steel | 2.8 |

From Table 7 it is clear that the use of the sol-gel coated on the Mn phosphate steel considerably decreased the wear depth, which shows that the sol-gel performs as a binder that enables much less manganese phosphate crystals to be lost from the first coating layer during operation.

In addition, the water-based sol-gel used in Example 1 could be stored for one month without showing any precipitation, whereas the solvent-based sol-gel used in Example 2 already showed clear precipitation after 2.5 days of storage.

Examples 5-9 also show that the second coating layer used in accordance with the present invention establishes improved anti-corrosion and anti-fretting properties when compared with embodiments in which only the first coating layer is used.

1. A machine component having:
a first tribological surface configured to be in contact with a second tribological surface of another machine component during a machine operation, wherein:
at least part of the first tribological surface is covered with a coating which comprises a first coating layer and a second coating layer,
the first coating layer comprises an inorganic protective coating composition,
the inorganic protective coating composition is a chemically produced coating composition that comprises at least one of black oxide or manganese phosphate,
the second coating layer comprises an organically modified silane composition,
an organically modified silane used in the organically modified silane composition contains one or more amine groups,
the first coating layer is in direct contact with at least part of the first tribological surface, and
the second coating layer is in direct contact with at least part of the first coating layer.

2. The machine component according to claim 1, wherein the organically modified silane used in the organically modified silane composition is water-soluble.

3. The machine component according to claim 1, wherein the organically modified silane is selected from the group consisting of aminoethyl silsesquioxane, aminoethyl aminopropyl silsesquioxane and 2-aminoethyl-3-aminopropyl-silanetriol.

4. The machine component according to claim 3, wherein the organically modified silane is aminoethyl-aminopropyl silsesquioxane or 2-aminoethyl-3-aminopropyl-silanetriol.

5. The machine component according to claim 1, wherein the second coating layer has a thickness in the range of from 25-500 nm.

6. (canceled)

7. The machine component according to claim 1, wherein the inorganic protective coating composition comprises manganese phosphate.

8. A process for preparing a coating on at least part of a first tribological surface of a first machine component which, during a machine operation, is configured to be in contact with a second tribological surface of another machine component, the process comprising:
(a) applying a first coating layer onto at least part of the first tribological surface, the first coating layer comprising an inorganic protective coating composition that is a chemically produced coating composition comprising one or more iron oxides or manganese phosphate, and the first coating being in direct contact with at least part of the first tribological layer;
(b) applying a second coating layer onto at least part of the first coating layer, the second coating layer comprising an organically modified silane which contains one or more amine groups, and the second coating layer being in direct contact with at least part of the first coating layer; and
(c) allowing the second coating to cure.

9. The process according to claim 8, wherein in step (b) the organically modified silane is in the form of an aqueous solution that is applied onto at least part of the first coating layer.

10. The process according to claim 8, wherein the organically modified silane is selected from the group consisting of aminoethyl silsesquioxane, aminoethyl aminopropyl silsesquioxane and 2-aminoethyl-3-aminopropyl-silanetriol.

11. The process according to claim 10, wherein the organically modified silane is aminoethyl-aminopropyl silsesquioxane or 2-aminoethyl-3-aminopropyl-silanetriol.

12. (canceled)

13. The process according to claim 8, wherein the inorganic protective coating composition comprises manganese phosphate.

14.-15. (canceled)

16. The machine component according to claim 2, wherein the organically modified silane used in the organically modified silane composition is water-soluble.

17. The machine component according to claim 16, wherein the organically modified silane is selected from the group consisting of aminoethyl silsesquioxane, aminoethyl aminopropyl silsesquioxane and 2-aminoethyl-3-aminopropyl-silanetriol.

18. The machine component according to claim 16, wherein the organically modified silane is aminoethyl-aminopropyl silsesquioxane or 2-aminoethyl-3-aminopropyl-silanetriol.

19. The machine component according to claim 18, wherein the second coating layer has a thickness in the range of from 25-500 nm.

20. The machine component according to claim 19, wherein the inorganic protective coating composition comprises manganese phosphate.
